(19) United States
(12) Patent Application Publication
(10) Pub. No.: US 2010/0021588 A1
(43) Pub. Date: Jan. 28, 2010

(54) Granulation Method And Additives With Narrow Particle Size Distribution Produced From Granulation Method

(75) Inventors: Robert Chatel, Hoffman Estates, IL (US); Yongsoo Chung, Palatine, IL (US); Ann Marie Baker, Cary, IL (US); Thomas S. Wolters, Algonquin, IL (US); Timothy A. Bell, Wilmington, DE (US); Steven W. Couch, Newark, DE (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignees: PepsiCo, Inc., Purchase, NY (US); E.I.Du Pont De Nemours And Company, Wilmington, DE (US)

(21) Appl. No.: 12/568,740

(22) Filed: Sep. 29, 2009

Related U.S. Application Data
(62) Division of application No. 11/853,876, filed on Sep. 12, 2007.

(51) Int. Cl. A23L 1/10; A23L 1/302; A23L 1/30; A23L 1/275

(52) U.S. Cl. 426/72; 426/618; 426/74

(57) ABSTRACT

A grain-based food product is provided which is formed from a premix compacted granules having a narrow particle size distribution. The premix flows easily, does not clump, and reduces dust.

### CROSS REFERENCE OF RELATED APPLICATION

This application is a divisional of U.S. patent application Ser. No. 11/853,876, filed Sep. 12, 2007. This application is incorporated herein by reference in its entirety.

### FIELD OF INVENTION

The present invention relates to additives having granules with narrow particle size distribution for addition to food products, in particular grain-based food products, and a granulation method for producing the additives.

### BACKGROUND OF THE INVENTION

Oatmeal has for many years been a staple of the human diet due to its health benefits. For example, numerous studies have shown that eating oatmeal on a daily basis can help lower blood cholesterol, reduce risk of heart disease, promote healthy blood flows as well as maintain healthy blood pressure levels. Additionally, oatmeal has high content of complex carbohydrates and fibers, which facilitates slow digestion and stable blood-glucose levels.

With today's hectic lifestyle, consumers are demanding convenience, such as portability and ease of preparation. Instant oatmeal is an ideal complement to today's hectic lifestyle. Instant oatmeal is easy to prepare, requiring only the addition of hot liquid, such as water. Additionally, instant oatmeal comes in a variety of flavors and is contained in convenient individual-serving sized packets.

### SUMMARY OF THE INVENTION

Aspects of the invention relate to preparing a premix of ingredients for addition to a food product to produce a flavored or fortified food product. In particular, the pre-mix is subjected to a granulation process to produce granules within a desired particle size distribution.

In one aspect, the granulation process first compacts the premix and then mills the pieces into granules. The granules are screened to provide granules within the desired particle size distribution.

These and other aspects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

FIG. 1 shows a process for forming a food product in accordance with one embodiment of the invention.

### DETAILED DESCRIPTION OF THE INVENTION

The present invention relates to preparing a premix of ingredients for addition to a food product to produce a flavored or fortified food product. In particular, the premix is subjected to a granulation process to produce granules within a desired particle size distribution.

Aspects of the invention allow production of premixes for food products, particularly grain-based food products, which are consistent in quality. Such premixes can be manufactured with reduced wastage allowing the cost of manufacturing to be reduced. Moreover, forming premixes having granules with a narrow particle size distribution reduces dust during filling since smaller particles are screened out and recycled.

The food product may be any suitable product for which a premix is added such as grain-based food products. Common grain-based food products utilizing such pre-mixes include instant oatmeal, non-instant oatmeal, or quick cook types of oatmeal. Other types of food products include, for example, cereal grain-based or non-cereal grain-based foods which are provided in instant, non-instant or quick cook forms such as grits, pasta, and rice. Non-grain-based food products may also prepared if the products require a narrower particle size distribution such as spice pre-mixes, flavorings, and fortification additives.

The grain-based food product may include, for example, cereal grain such as oat, wheat, corn (maize), rice, barley, millet, sorghum (milo), rye, triticale, teff, wild rice, spelt, buckwheat, amaranth, quinoa, kaniwa, cockscomb or a combination thereof (e.g., multi-grain). The cereal grain-based or non-cereal grain-based food product which are provided in instant, non-instant, or semi-instant forms are also contemplated and within the scope of the invention. For instance, the grain-based food product may be instant oatmeal.

In accordance with an aspect of the invention, the premix is formed into granules having a desired, generally narrow, particle size distribution. The distribution range of the premix granules may be from at least 400, at least 600, or at least 630 microns to at most 2000, at most 1700, or at most 1530 microns. For example, the distribution range may be 400 to 2,000 microns, 600 to 1700 microns, or 630 to 1530 microns.

Moreover, the size distribution can reflect desired particle sizes within the distribution range. For example, the size distribution can have 35-75% of the granules in the 850 to 1500 micron range and 25-45% in the 600 to 850 micron range or, as another example, the size distribution can have 45% to 65% (e.g. 55%) of the granules in the 860 to 1530 micron range and 30% to 40% (e.g. 35%) in the 630 to 860 micron range.

The desired sizes are obtained by screening, for example. The sizes correspond to granules that can or cannot pass through openings in industrial sieves or screens. Generally, the minimum particle size of the granules is large enough to eliminate the dust. The maximum particle size is generally selected to optimize appearance and maintain an acceptable rate of dissolution during preparation of the product. If the particle size of the granules is too large, the granules look like fine gravel and will not dissolve fast enough.

For a grain-based product, such as oatmeal, the premix includes a blend of salt, guar gum, vitamins, and minerals as basic ingredients. Additional ingredients added to the premix include flavoring agents, coloring agents, sweeteners such as sugar and fruit sugar, and/or food stabilizers. At least the sweetener or another ingredient should behave as a binder for agglomerating the premix into the granules.

Although molecular, electrical and magnetic forces provide attraction forces to bind particles together, agglomeration techniques, such as roll compaction, do not work for all particles unless binders are present, for example, sugar.

In one aspect, the particle sizes of the ingredients selected for the premix should be smaller than the smallest particle size of the desired particle size range of the desired granules. This way, uncompacted ingredient particles are not classified as finished product during the screening process. Instead, they are removed during the screening process and recycled.

For example, if the granules are desired having a distribution size of 630 to 1530 microns, the particle sizes of the ingredients in the premix should be less than 630 microns. For example, fruit sugar typically has a particle size of about 250 to 310 microns, and non-compacted fruit sugar particles will be screened out.

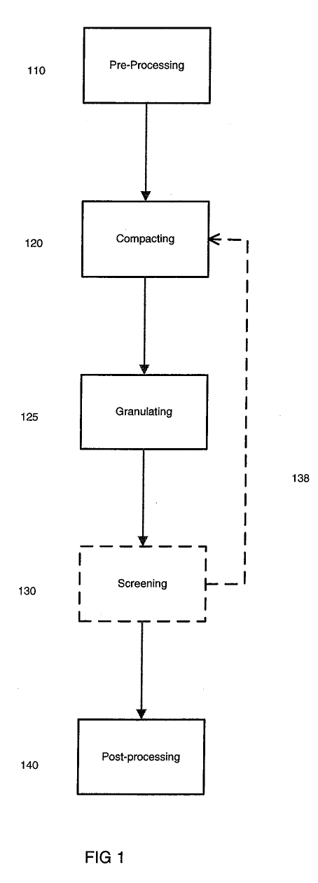

FIG. 1 shows a process 100 for forming a grain-based food product in accordance with one embodiment of the invention. At step 110, pre-processing is performed to form a pre-mix. In one embodiment, pre-processing forms instant oatmeal pre-mix. Other types of pre-mixes can also be formed. For example, non-instant oatmeal, quick oatmeal or other types of grain-based or non grain-based pre-mixes can be formed.

Various conventional techniques can be used to form the pre-mix such as, for example, rotary blending, tumble blending, gravity/static blending, or continuous blending.

Individual ingredients are weighed and added to a batch mixer in which they are blended together. For example, the ingredients are loaded into Intermediate Bulk Containers (IBC's) (portable containers) and then tumbled. Suitable blenders may be “Koch” static blenders; “Patterson-Kelley” zig-zag (continuous) blenders; and “Matcon” IBC containers and tumble-blenders.

Any suitable ingredients may be included in the pre-mix. At least one of the ingredients should be a binder or an ingredient that has binding effect such as sugar. Suitable ingredients include, for example, flavoring agents, coloring agents, sweeteners such as sugar and fruit sugar, salt, guar gum, food stabilizer, as well as vitamins and minerals. Other nutritional ingredients may be added if they do not interfere with compaction.

Typically, the premix is pre-processed by dry-granular mixing, but can also be tempered with a hydrous solution, for example, up to 3% water (on a wet basis) can be added.

At steps 120 and 125, the premix is formed into granules. The particle size distribution of the granules is typically much narrower than the particle size distribution of the premix and generally the smallest particle size of the granule product is larger than the largest particle size of the premix.

The granulating process generally involves three steps. The first step, 120, compacts the premix between two rolls. The second step, 125, grinds or ganulates the resulting compact in a mill. The third step screens the material exiting the mill to obtain the desired particle size range. The granules that are too coarse or too fine can be recycled.

Thus, the premix is first processed by a roll compactor, for example. Various conventional roll compactors can be used. A roll compactor compacts the premix into granules. Unlike flaking rolls, the feeders on a roll compactor are designed to fill the entire length of rolls with material to be compacted in order to produce a more consistent compact and ultimately a higher yield of the desired particle size. Suitable roll compactors include the Fitzpatrick Chilsonator, and roll compactors made by Hosakawa Bepex and K.R. Komarek.

A screw feeder, for example, can be provided to facilitate feeding the premix to the compacting rolls.

The compactor includes a pair of counter rotation rolls. The rolls can be smooth, knurled, axially or radially grooved. If grooves are used, then the compact exiting the rolls resembles pieces of chalk. As the volume decreases through the region of maximum pressure between the rolls, the pre-mix is formed into a solid compacted sheet or ribbon.

The rolls can include a corrugated face pattern to provide fracture points in the resulting compacted sheet to facilitate subsequent processing, such as milling. The process parameters of the compactor, for example, pressure, gap between the rolls, speed of the rolls, speed that the pre-mix is provided, can be selected to produce the desired sheet characteristics. The speed of the horizontal and vertical feeders that supply material to the nip of the rolls can be adjusted as necessary.

The sheet should have sufficient thickness or strength to keep the granules from breaking. For example, the compacted sheet can be about ¼″ thick.

The compacted sheet is then processed into granules of desired uniform particle size or range. In one aspect, a granulator can be employed to process the compacted sheet. The granulator, for example, can be integrated as part of the compactor or be a separate non-integrated unit. The granulator typically comprises a mill with rotor equipped hammers or knives to break large particles into smaller particles. The particles are forced through a screen with openings sized to make the desired particle size. Examples of commercially available granulators include the FitzMill granulator.

The particle size distribution can be measured by, for example, a Ro-Tap particle size distribution analysis.

At step 130, the granules are screened to segregate granules within the desired particle size distribution range. Granules outside the range, for example under-sized granules including dust (fines) and over-sized granules (overs), are removed. In one embodiment, the fines are recycled by feeding back to the compactor, as indicated by dotted line 138. Overs are fed back to the granulator.

Screening can be achieved using, for example, a screener. The screener can be any type of conventional screener known in the art. For example, the screener can be a Rotex screener. The screener may be integrated into the compactor such as in the Chilsonator compactor with an integrated screener. Screeners generally have a plurality of screens, such as 2-5 screens, which are generally metallic mesh used in all types of aggregate-particle separation/segregation.

The overs and fines can be separated by a pair of screens with the desired mesh rating. For example, the screens can have U.S. Standard mesh ratings respectively of No. 12 and No. 30 to separate granules. US sieves of this mesh have 540 to 1530 micron openings. Industry available wire cloths include Market Grade wire for the 12 mesh and Tensile Bolt Cloth for the finer 30 mesh. To obtain particles greater than 630 microns, a 32 mesh Stainless Steel Tensile Bolt cloth with a 0.0248 inch opening and 0.0065 inch diameter wire can be used. To obtain particles smaller than 1530 microns, a 12 mesh Market Grade wire cloth with a 0.0603 inch opening and 0.023 inch diameter wire can be used. Other types of configurations and/or mesh ratings are also useful, for example, to suit different product designs and process requirements.

At step 140, the granules are post-processed into the final grain-based food product. In one embodiment, the granules are metered or filled into suitable packages. The grains, e.g. oats, are added to the packages before, during, or after the granules are added. Typically, the granules are added first followed by the oats. Conventional filling or packaging equipment can be used. While a pouch, bag or packet is preferred, other physical containment devices such as a cup or spoon can also be included. The package can contain convenient single servings of the grain-based food product, or multiple servings, depending on the product design.

An advantage of the invention is that the resulting grain-based food product has a substantially uniform consistency of granules, which reduces segregation and facilitates more consistent metering and analysis. In addition, since dust is significantly reduced, the cost of maintaining the packaging equipment is greatly reduced. The dust is reduced due to dust being removed during screening and because the compacted granules do not break or crumble which produces less dust. Cross-contamination and loss of product are also reduced, improving process yield. Further, since granular materials flow more easily and resist bridging and caking, higher flow rates and throughput, as well as more even fill can also be achieved.

### EXAMPLES

A maple and brown sugar instant oatmeal was prepared with a premix including, sugar, natural and artificial flavors, salt, calcium carbonate, guar gum, caramel color, niacinamide, vitamin A palmitate, reduced iron, pyridoxine hydrochloride, riboflavin, thiamin mononitrate and folic acid. The premix was compacted, granulated, and screened to obtain granules having a nominal particle size distribution of from 600 to 1,700 microns. The particle size distribution based upon a Ro-Tap analysis is given in the below.

| Micron Range | % |
|---|---|
| Greater than | <0.5 |
| 1,700 | |
| 850-1,700 | 52 |
| 600-850 | 33 |
| 300-600 | 14 |
| Less than 300 | <0.5 |

The premix was combined with instant oatmeal. Upon addition of heated water, the premix dissolved completely.

The invention may be embodied in other specific forms without departing form the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A flavored or fortified grain-based product, comprising at least one grain and a premix wherein the premix comprises granulated particles having a particle size distribution of from 400 to 2,000 microns and wherein the premix comprises at least one ingredient effective as a binder.

2. The product of claim 1 wherein the particle size distribution is 600 to 1700 microns.

3. The product of claim 1 wherein the particle size distribution is 630 to 1530 microns.

4. The product of claim 1 wherein the size distribution has 45% to 65% of the granules in the 860 to 1530 micron range and 30% to 40% in the 630 to 860 micron range.

5. The product of claim 1 wherein the premix includes at least one ingredient selected from flavoring agents, coloring agents, sweeteners, salt, guar gum, food stabilizers, vitamins, minerals, binders, and combinations thereof.

6. The product of claim 1 wherein the premix includes at least one sweetener wherein the sweetener is effective as a binder.

7. The product of claim 1 wherein the granulated premix is prepared by compacting a premix of ingredients, granulating the premix to form granules, and screening the granules.

8. A flavored or fortified food product comprising at least oatmeal and a premix wherein the premix comprises granulated particles having a particle size distribution of from 400 to 2,000 microns, and wherein the premix comprises at least one ingredient effective as a binder.

9. The product of claim 8 wherein the particle size distribution is 600 to 1700 microns.

10. The product of claim 8 wherein the particle size distribution is 630 to 1530 microns.

11. The product of claim 8 wherein the granulated premix is prepared by compacting a premix of ingredients, granulating the premix to form granules, and screening the granules.

12. The product of claim 8 wherein the size distribution has 45% to 65% of the granules in the 860 to 1530 micron range and 30% to 40% in the 630 to 860 micron range.

13. The product of claim 8 wherein the premix includes at least one ingredient selected from flavoring agents, coloring agents, sweeteners, salt, guar gum, food stabilizers, vitamins, minerals, binders, and combinations thereof.

14. The product of claim 8 wherein the premix includes at least one sweetener wherein the sweetener is effective as a binder.
